(19) United States
(12) Patent Application Publication
(10) Pub. No.: US 2021/0114841 A1
(43) Pub. Date: Apr. 22, 2021

(54) METHOD FOR MONITORING BRAKE DRAGGING OF AN ELEVATOR

(71) Applicant: KONE Corporation, Helsinki (FI)

(72) Inventors: Alessio Calcagno, Helsinki (FI); Markku Jokinen, Helsinki (FI); Ari Kattainen, Helsinki (FI); Juha-Matti Aitamurto, Helsinki (FI); Janne Salomäki, Helsinki (FI)

(73) Assignee: KONE Corporation, Helsinki (FI)

(21) Appl. No.: 17/015,492

(22) Filed: Sep. 9, 2020

(30) Foreign Application Priority Data
Oct. 18, 2019 (EP) 19204067.3

(51) Int. Cl. B66B 5/00; B66B 1/34

(52) U.S. Cl. CPC B66B 5/0025; B66B 1/3461

(57) ABSTRACT

A method includes calculating a motor torque estimate for an electric motor of an elevator in an elevator run, determining a difference between the calculated motor torque estimate and a realized motor torque during the elevator run, and generating a signal indicating possible brake dragging based on the difference between the motor torque estimate and the realized motor torque.

### FIELD

The invention relates to a method for monitoring brake dragging of an elevator.

### BACKGROUND

An elevator may comprise a car, a shaft, hoisting machinery, a hoisting member, and a counterweight. A separate or an integrated car frame may surround the car.

The hoisting machinery may be positioned in the shaft. The hoisting machinery may comprise a drive, an electric motor, a traction sheave, and a machinery brake. The hoisting machinery may move the car upwards and downwards in the shaft. The machinery brake may stop the rotation of the traction sheave and thereby the movement of the elevator car.

The car frame may be connected by the hoisting member via the traction sheave to the counterweight. The hoisting member may be formed of one or more ropes having a flat or round cross section. The ropes may be made of steel and/or of fibre reinforced polymer. The car frame may further be supported with guiding means at guide rails extending in the vertical direction in the shaft. The guide rails may be attached with fastening brackets to the side wall structures in the shaft. The guiding means keep the car in position in the horizontal plane when the car moves upwards and downwards in the shaft. The counterweight may be supported in a corresponding way on guide rails that are attached to the wall structure of the shaft.

The car may transport people and/or goods between the landings in the building. The shaft may be formed so that the wall structure is formed of solid walls or so that the wall structure is formed of an open steel structure.

The machinery brake may be formed of at least one electromechanical brake which is used as a safety device to apply braking force to the traction sheave or the rotating axis of the hoisting machinery in order to stop the movement of the hoisting machinery and thereby also of the elevator car. A machinery brake may comprise two separate electromechanical brakes. The brakes should be able to stop and hold an elevator car with nominal load standstill in the elevator shaft. The brakes should further protect passengers from unintended car movement at a landing and to provide a safe operating environment for a technician inside the elevator shaft. It is thus necessary to ensure that the brakes are operating correctly. For example, if the brakes do not open correctly, the brake pad may drag against the traction sheave during the run of the elevator car. This may cause accelerated wear of the brake pad and the brake surface, which may further lead to degradation of the braking force.

Correct opening of the brake may be monitored with a sensor, e.g. with a brake switch. A brake switch changes its state when the brake opens. Brake switches may, however, be expensive, unreliable and sometimes difficult to fit into the brakes.

Sometimes the brake switch does not notice that the brake has not opened completely. This means that a brake dragging situation may continue for a longer period, causing problems such as momentary interruptions in the use of the elevator.

An electromagnetic brake may comprise an armature connected to a brake shoe and a magnetic core being wound by a coil. The armature may be loaded by spring means in relation to the magnetic core. When no current passes through the coil of the electromagnetic brake, then the spring means presses the armature and thereby also the brake shoe against the brake surface. Rotation of the elevator machinery is thus prevented. When current passes through the coil of the electromagnetic brake, then the attraction between the electromagnetic core and the armature moves the brake shoe away from the brake surface. The elevator machinery is thus free to rotate.

### SUMMARY

An object of the invention is an improved method for monitoring brake dragging of an elevator.

The method for monitoring brake dragging of an elevator according to the invention is defined in claim 1.

The method comprises

calculating a motor torque estimate for an electric motor of the elevator in an elevator run,

determining a difference between the calculated motor torque estimate and a realized motor torque during the elevator run,

generating a signal indicating possible brake dragging based on the difference between the motor torque estimate and the realized motor torque.

The method for monitoring brake dragging is based on the idea of determining a difference between a calculated motor torque needed for driving the elevator car in an elevator run and an actual motor torque needed for driving the elevator car in the elevator run.

A signal indicating possible brake dragging is generated if said difference meets or exceeds predetermined criteria. Said difference may in practice be the output signal of the speed controller. The speed controller may compare the speed reference signal to the actual speed and generate the output signal based on the difference. The speed controller may thus generate a non-zero output value when the calculated motor torque needed for driving the elevator in an elevator run car does not correspond to the actual motor torque needed for driving the elevator car in the elevator run. The actual speed of the elevator car may be measured with e.g. a motor encoder measuring the rotation speed of the motor of the elevator.

The inventive method may be applied during normal elevator operation to test brake dragging i.e. to test that the machinery brake opens properly.

The inventive method may be applied as such for monitoring brake dragging. It will be possible, based on the inventive method, to determine whether the brake opens physically when a brake open command has been issued.

The inventive method may on the other hand also be applied in combination with some other brake monitoring method. The inventive method could e.g. be used in combination with a prior art method for monitoring brake dragging based on brake current measurement. In the prior art method for monitoring brake dragging, the brake current is measured, whereby the presence of a brake current during a predetermined time indicates that the brake will open correctly.

The inventive method may be realized in the software of the elevator, e.g. in the software of the motor drive unit. The motor drive unit may be formed of a frequency converter. The inventive method does not require any new hardware to be installed into the elevator.

### DRAWINGS

The invention will in the following be described in greater detail by means of preferred embodiments with reference to the attached drawings, in which

FIG. 1 shows a side view of an elevator,

FIG. 2 shows a view of an elevator machinery brake,

FIG. 3 shows a view of an elevator machinery brake system,

FIG. 4 shows a torque control principle block diagram,

FIG. 5 shows a monitoring function filtering principle,

FIG. 6 shows a motor torque monitoring sequence diagram.

### DETAILED DESCRIPTION

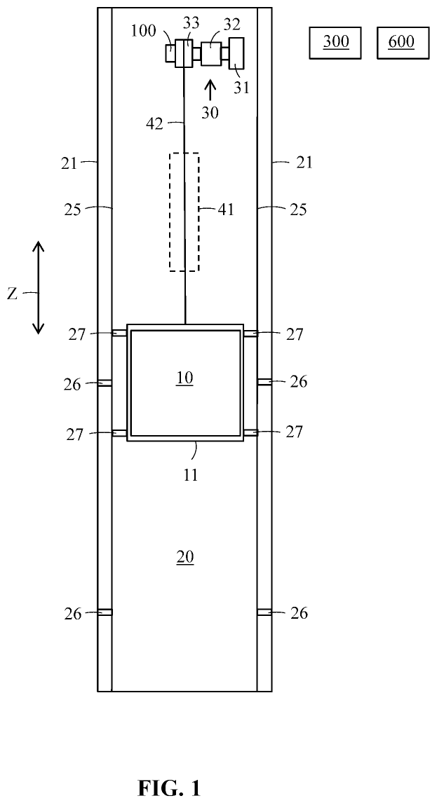

FIG. 1 shows a side view of an elevator.

The elevator may comprise a car 10, an elevator shaft 20, hoisting machinery 30, a hoisting member 42, and a counterweight 41. A separate or an integrated car frame 11 may surround the car 10. The elevator may further comprise a main controller 300 controlling the elevator. The elevator may still further comprise a communication link 600 providing a communication channel to a remote service centre.

The hoisting machinery 30 may be positioned in the shaft 20. The hoisting machinery 30 may comprise a motor drive unit 31, an electric motor 32, a traction sheave 33, and a machinery brake 100. The hoisting machinery 30 may move the car 10 in a vertical direction Z upwards and downwards in the vertically extending elevator shaft 20. The machinery brake 100 may stop the rotation of the traction sheave 33 and thereby the movement of the elevator car 10.

The car frame 11 may be connected by the hoisting member 42 via the traction sheave 33 to the counterweight 41. The hoisting member 42 may be formed of one or more ropes having a flat or round cross section. The ropes may be made of steel and/or of fibre reinforced polymer. The car frame 11 may further be supported with guiding means 27 at guide rails 25 extending in the vertical direction in the shaft 20. The guiding means 27 may comprise rolls rolling on the guide rails 25 or gliding shoes gliding on the guide rails 25 when the car 10 is moving upwards and downwards in the elevator shaft 20. The guide rails 25 may be attached with fastening brackets 26 to the side wall structures 21 in the elevator shaft 20. The guiding means 27 keep the car 10 in position in the horizontal plane when the car 10 moves upwards and downwards in the elevator shaft 20. The counterweight 41 may be supported in a corresponding way on guide rails that are attached to the wall structure 21 of the shaft 20.

The car 10 may transport people and/or goods between the landings in the building. The elevator shaft 20 may be formed so that the wall structure 21 is formed of solid walls or so that the wall structure 21 is formed of an open steel structure.

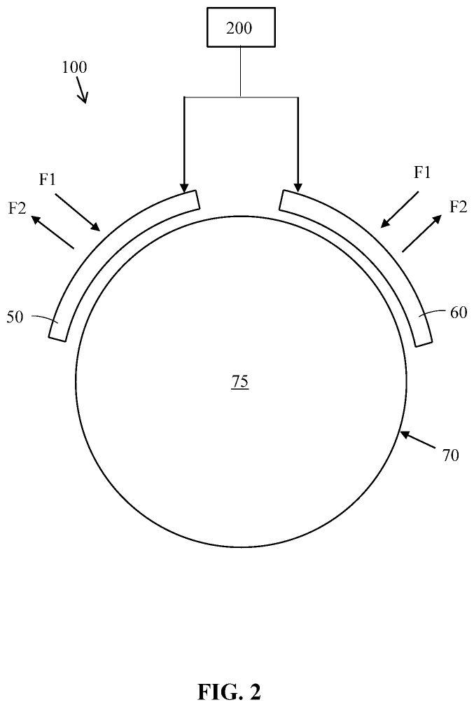

FIG. 2 shows a view of an elevator machinery brake.

The figure shows a machinery brake controller 200 and a machinery brake 100. The machinery brake 100 may comprise two brake shoes 50, 60 acting on a brake surface 70. The brake surface 70 may be provided on a drum 75 having a shaft connected to the machinery. Each brake shoe 50, 60 may be loaded with spring means producing a spring force F1 that presses the brake shoe 50, 60 against the brake surface 70. The spring force F1 presses the brake shoes 50, 60 against the brake surface 70 with a force being able to stop the rotation of the drum 75 and thereby also the rotation of the elevator machinery 30. When the rotation of the traction sheave 33 stops then also the movement of the car 10 and the counterweight 41 stops.

Each brake shoe 50, 60 may further be connected to an electromagnet. The electromagnet may comprise an armature connected to the brake shoe 50, 60 and a magnetic core comprising a coil wound around a core. The magnetic core attracts the armature when a current is flowing through the coil in the electromagnet. The brake shoe 50, 60 is thus moved away from the brake surface 70 when the electromagnet is energized. This means that the brake is deactivated when the electromagnet is activated. The spring means will on the other hand press the brake shoes 50, 60 against the brake surface 70 when the electromagnet is deactivated. The attraction force F2 of the electromagnet is bigger than the spring force F1. The armature and thereby also the brake shoe 50, 60 will thus move towards the magnetic core when the electromagnet is energized. This means that the brake is deactivated when the electromagnet is activated.

The brake controller 200 may control the machinery brake 100 i.e. the electromagnets in the machinery brake 100. The controller 200 may control the current supplied to the coils in the electromagnets.

The machinery brake operates in the following way:

The machinery brake controller 200 keeps the electromagnet in an activated state i.e. keeps the current supply to the electromagnet switched on when the elevator is operated in a normal state. The armature is thus pulled towards the core, whereby the brake shoe 50, 60 is at a distance from the brake surface 70. The hoisting machinery 30 may thus operate normally.

The machinery brake controller 200 disconnects the current supply to the electromagnet i.e. deactivates the electromagnet, when the elevator car 10 is to be stopped. Deactivation of the electromagnet is realized by disconnecting the current flowing through the coil in the electromagnet so that the magnetic field keeping the armature part pulled towards the core is disconnected. The spring means will thus push the armature away from the core, whereby the brake shoe 50, 60 will be pushed against the brake surface 70. The rotation of the traction sheave 33 will thus be stopped, whereby also the car 10 is stopped.

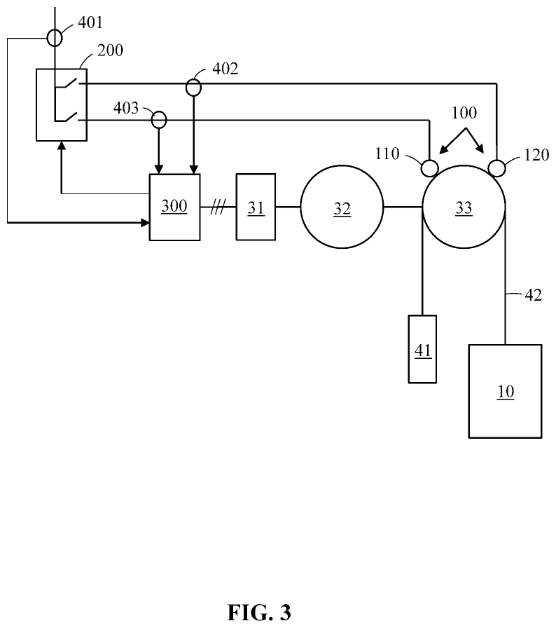

FIG. 3 shows a side view of an elevator machinery brake system.

The car 10 is hanging on a first side of the traction sheave 33 and the counterweight 41 is hanging on an opposite second side of the traction sheave. The hoisting member 42 passes from the car 10 over the traction sheave 33 and to the counterweight 41. The traction sheave 33 is driven by the electric motor 32 which may be formed of a permanently magnetized synchronous electric motor. The machinery brake 100 comprises two electromagnetic brakes 110, 120 acting on the traction sheave 33. The electromagnetic brakes 110, 120 are controlled by a machinery brake controller 200. The electric motor 32 is controlled by a motor drive unit 31, e.g. a frequency controller. The elevator is controlled by a main controller 300.

There are three options for testing the proper function of the electromagnetic brakes 110, 120 based on brake current measurements.

A first option is to determine the proper function of the two brakes 100 one at a time. One common current sensor 401 may be used in this first option in order to measure the current supplied to the brakes 100 from the machinery brake controller 200.

A second option is to determine the proper function of the two brakes 110, 120 simultaneously based on the magnitude of the brake current. One common current sensor 401 may be used in this second option in order to measure the brake current supplied to the brakes 110, 120 from the machinery brake controller 200. The current sensor 401 must, however, be more accurate in this second option compared to the current sensor 401 in the first option. This is because the current sensor must be able to indicate the difference between the current of one brake and the common current of two brakes.

A third option is to determine the proper function of the two brakes 110, 120 simultaneously based on the brake current supplied to each brake. Two current sensor 402, 403 are needed in this third option in order to measure the current supplied to each of the two brakes 110, 120 from the machinery brake controller 200.

The machinery brake 100 in the figure shows two independent brakes 110, 120. The two brakes 110, 120 may be commanded to open simultaneously at the beginning of a new elevator run sequence and commanded to open alternatively in connection with a brake test sequence. A machinery brake with two independent brakes 110, 120 is common in most countries e.g. in Europe and in China. However, in some countries as e.g. in the USA, machinery brakes with one main brake and one separate emergency brake is commonly used. In a normal elevator run, only the main brake is used. The emergency brake is only used in emergency situations.

A method for monitoring brake dragging based on brake current measurements in accordance with FIG. 3 is disclosed in EP patent application No. 19160536 filed on 4 Mar. 2019. The invention in the present application may be used as such for monitoring brake dragging or it may be used in combination with e.g. said prior art method disclosed in EP patent application No. 19160536.

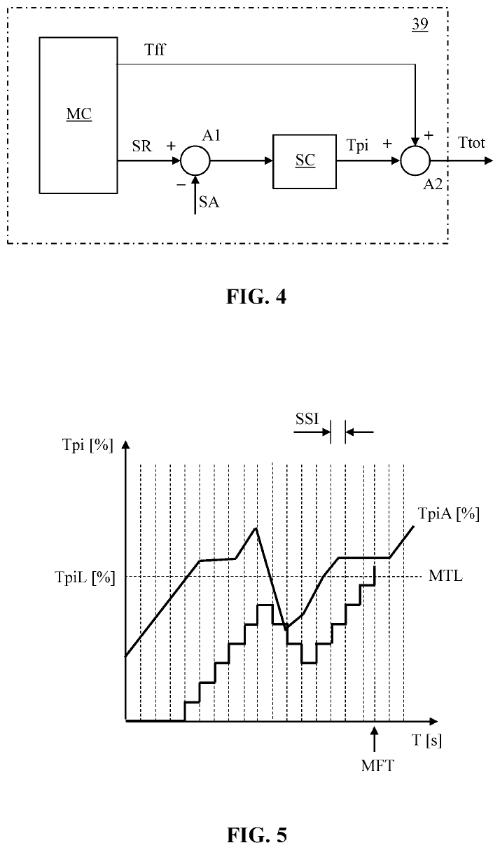

FIG. 4 shows a torque control principle block diagram.

The figure shows a controller 39 comprising a motion control MC and a speed control SC of an electric drive. The motion control MC provides a speed reference SR to a first input of a first adder A1. An actual speed signal SA is provided to a second input of a first adder A1. The actual speed signal SA may be measured e.g. with an encoder measuring the rotation speed of the electric motor of the elevator. The output of the first adder A1 is connected to an input in the speed control SC. The speed control SC provides a torque correction signal Tpi as the output signal. The output of the speed controller SC is connected to a first input in a second adder A2. The motion control MC provides further a calculated torque feedforward reference signal Tff which is connected to a second input in the second adder A2. The output of the second adder A2 provides the total torque signal Ttot to the electric motor of the elevator. The output of the first adder A1 represents the difference between the speed reference SR and the actual speed SA. The output of the second adder A2 represents the sum of the torque feed forward reference signal Tff and the torque correction signal Tpi.

The torque feedforward reference Tff may be calculated during the run of the elevator in the motion control MC based on at least the following input variables:

The rated load (parameter),

The load information from the load weighing device (measured),

The balancing percent and the compensation (parameter),

The position dependent masses, i.e. masses varying in accordance with the position of the elevator car (parameter),

The total moving masses (KTW/Q) (parameter),

The shaft efficiency (constant),

The acceleration reference of the elevator (parameter).

All of the input variables in the list or any combination of the input variables in the list may be used when calculating the torque feedforward reference Tff.

The output of the speed controller SC, i.e. the torque correction signal Tpi is zero, if there is no need for correction and the electric motor of the elevator rotates with the set speed with the estimated feedforward torque Tff.

An increase or a decrease in the required motor torque results in changes in the output of the speed controller SC i.e. in the torque correction signal Tpi.

The following criteria may be used when determining whether the machinery brake works properly or not.

If the torque correction signal Tpi exceeds 70% of the nominal torque of the electric motor of the elevator for a time period of 200 ms, fault is detected.

It the torque correction signal Tpi exceeds 40% of the nominal torque of the electric motor of the elevator for a time period of 4000 ms, fault is detected.

The criteria are based on the magnitude of the torque correction term Tpi as well as on the duration of the correction. The criteria should be selected so that false alarms are avoided. False alarms may impair the elevator operation and/or they may cause unnecessary maintenance calls.

When brake dragging is determined, the elevator is driven to the nearest floor and taken out of service. If the elevator is already at the door zone of a landing when the brake dragging is determined, then the car is stopped immediately, and the elevator is taken out of service.

The problem causing brake dragging may be dealt with and the elevator operation may be resumed by operating a manual reset switch, e.g. an RFD mode switch, or by generating a power reset. RDF mode is a drive mode in which one or more of the elevator safety circuits are bypassed.

FIG. 5 shows a monitoring function filtering principle.

The figure shows the torque correction signal Tpi in percentage as a function of the time T in seconds. The vertical dashed lines in the figure indicate the signal sampling interval SSI. The actual torque correction signal TpiA is the broken line and the filtered signal is the stepped line in the figure. A monitoring time limit MTL i.e. a limit in percentage for the torque correction signal TpiL is further shown in the figure. The monitoring function triggering point MFT is further shown in the figure.

When a fault is detected outside the electrical door zone control system, a fault code is set and the elevator controller will attempt to recover the car to the nearest floor. When the car has reached the nearest floor level, the elevator is taken out of service and a second fault code is set.

When a fault is detected within the electrical door zone control system, a fault code is set and the elevator is taken out of service.

The fault is reset by activating an RDF mode or in a power interruption. The RDF mode is a drive mode in which one or more of the elevator safety circuits are bypassed.

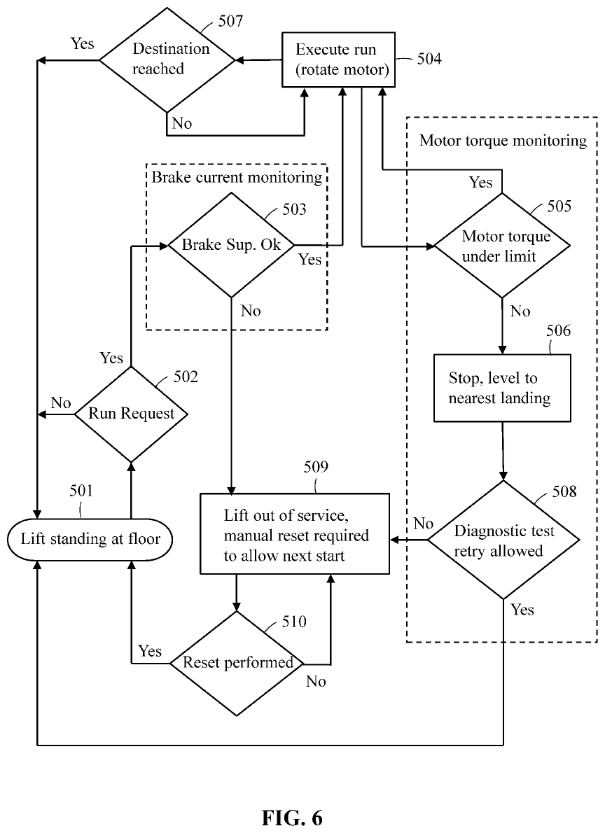

FIG. 6 shows a motor torque monitoring sequence diagram.

The figure shows a situation in which the invention i.e. the motor torque monitoring is used in combination with a prior art brake current monitoring.

Step 501 comprises a situation in which the elevator car 10 is standing on a landing.

Step 502 comprises issuing a run request by the elevator controller 300. The run request may be initiated by a person pressing the up or down bottom of the elevator in a control panel on a landing.

Step 503 comprises performing brake current monitoring after the run request has been received according to a prior art method. The brake current is measured and if a break current meeting or exceeding a predetermined threshold within a predetermined time period is detected, then the machinery brake is considered to work properly.

Step 504 comprises, if the answer in step 503 is yes, i.e. if the measured brake current meets or exceeds a predetermined threshold within a predetermined time period, then issuing a command to execute run i.e. rotate the motor of the elevator.

Step 505 comprises monitoring the motor torque. The motion controller MC calculates a motor torque feed forward reference Tff as an estimate for the motor torque needed to drive an elevator car from a departure landing to a destination landing. This motor torque feed forward reference Tff is compared with the output of the speed controller SC i.e. with the torque correction signal Tpi. Brake dragging is determined based on the magnitude of the torque correction signal Tpi and/or based on the duration of said magnitude.

Step 506 comprises, if the answer in step 505 is no, i.e. the magnitude of the torque correction signal Tpi exceeds a predetermined threshold for a predetermined time period, then the elevator car is stopped and the elevator car is levelled to the nearest landing.

If the answer in step 505 is yes, then the run continues in step 504 until the destination landing has been reached in step 507. The elevator car 10 is then standing at the destination landing in step 501 when the destination landing has been reached.

Step 508 comprises a diagnostic test. Retry is in most countries allowed, but not in China. If the machinery brake passes the diagnostic test and retry is allowed, then the elevator car is at the landing in step 501 and ready for a run request.

Step 509 comprises, if the answer in step 508 is no, i.e. if the machinery brake did not pass the diagnostic test, then the lift is taken out of service. A manual reset is then required in order to allow the next start of the lift. If the machinery brake fails the brake test in brake current monitoring in step 503, then the procedure continues with step 509.

Step 510 comprises performing the manual reset of the lift after which the lift is at the landing in step 501 and ready for a run request.

The use of the invention is not limited to the elevator disclosed in the figures. The invention can be used in any type of elevator e.g. an elevator comprising a machine room or lacking a machine room, an elevator comprising a counterweight or lacking a counterweight. The counterweight could be positioned on either side wall or on both side walls or on the back wall of the elevator shaft. The drive, the motor, the traction sheave, and the machine brake could be positioned in a machine room or somewhere in the elevator shaft. The car guide rails could be positioned on opposite side walls of the shaft or on a back wall of the shaft in a so called ruck-sack elevator.

It will be obvious to a person skilled in the art that, as the technology advances, the inventive concept can be implemented in various ways. The invention and its embodiments are not limited to the examples described above but may vary within the scope of the claims.

1. A method for monitoring brake dragging of an elevator, the method comprising the steps of:
calculating a motor torque estimate for an electric motor of the elevator in an elevator run;
determining a difference between the calculated motor torque estimate and a realized motor torque during the elevator run; and
generating a signal indicating possible brake dragging based on the difference between the motor torque estimate and the realized motor torque.

2. The method according to claim 1, wherein the signal indicating possible brake dragging is generated based on the magnitude of the difference between the motor torque estimate and the realized motor torque and based on the duration of said magnitude.

3. The method according to claim 1, wherein the signal indicating possible brake dragging is generated when the difference between the motor torque estimate and the realized motor torque meets or exceeds a predetermined threshold for a predetermined time period.

4. The method according to claim 1, wherein the signal indicating possible brake dragging is generated when the difference between the motor torque estimate and the realized motor torque meets or exceeds a first predetermined threshold for a first predetermined time period or when the difference between the motor torque estimate and the realized motor torque meets or exceeds a second predetermined threshold for a second predetermined time period, the value of the second threshold being lower than the value of the first threshold and the second time period being longer than the first time period.

5. The method according to claim 1, wherein the motor torque estimate is calculated based on all or of any combination of the following criteria: the rated load, the output of the load weighing device, the balancing percent and the compensation, the position of the dependent masses, the total moving masses, the shaft efficiency, and the acceleration reference.

6. The method according to claim 1, wherein the realized motor torque is the output of the speed control in a speed control circuit.

7. The method according to claim 1, wherein the signal indicating possible brake dragging based on the difference between the motor torque estimate and the realized motor torque is transmitted to a remote service centre.

8. A brake monitoring apparatus, comprising:
a drive unit configured to drive an elevator car; and
a controller comprising an elevator speed control circuit,
wherein the controller is configured to perform the method according to claim 1, and
wherein the brake monitoring apparatus further comprises a signal generator configured to generate a signal indicating possible brake dragging.

9. An elevator comprising the brake monitoring apparatus according to claim 8.

10. The elevator according to claim 9, wherein the elevator comprises a remote communication link to a remote service centre.

11. A computer program product embodied on a non-transitory computer readable medium and comprising program instructions, which, when run on a computer, causes the computer to perform the method as claimed in claim 1.

12. The method according to claim 2, wherein the motor torque estimate is calculated based on all or of any combination of the following criteria: the rated load, the output of the load weighing device, the balancing percent and the compensation, the position of the dependent masses, the total moving masses, the shaft efficiency, and the acceleration reference.

13. The method according to claim 3, wherein the motor torque estimate is calculated based on all or of any combination of the following criteria: the rated load, the output of the load weighing device, the balancing percent and the compensation, the position of the dependent masses, the total moving masses, the shaft efficiency, and the acceleration reference.

14. The method according to claim 4, wherein the motor torque estimate is calculated based on all or of any combination of the following criteria: the rated load, the output of the load weighing device, the balancing percent and the compensation, the position of the dependent masses, the total moving masses, the shaft efficiency, and the acceleration reference.

15. The method according to claim 2, wherein the realized motor torque is the output of the speed control in a speed control circuit.

16. The method according to claim 3, wherein the realized motor torque is the output of the speed control in a speed control circuit.

17. The method according to claim 4, wherein the realized motor torque is the output of the speed control in a speed control circuit.

18. The method according to claim 5, wherein the realized motor torque is the output of the speed control in a speed control circuit.

19. The method according to claim 2, wherein the signal indicating possible brake dragging based on the difference between the motor torque estimate and the realized motor torque is transmitted to a remote service centre.

20. The method according to claim 3, wherein the signal indicating possible brake dragging based on the difference between the motor torque estimate and the realized motor torque is transmitted to a remote service centre.
